(19) United States
(12) Patent Application Publication
(10) Pub. No.: US 2004/0115364 A1
(43) Pub. Date: Jun. 17, 2004

(54) Method for the production of a functional coating by means of high-frequency plasma beam source

(76) Inventors: Stefan Grosse, Gerlingen (DE); Sascha Henke, Weil Der Stadt (DE); Susanne Spindler, Stuttgart (DE)

Correspondence Address: KENYON & KENYON, ONE BROADWAY, NEW YORK, NY, 10004, US

(21) Appl. No.: 10/470,926

(22) PCT Filed: Nov. 21, 2001
(86) PCT No.: PCT/DE01/04357

(30) Foreign Application Priority Data
Feb. 2, 2001 (DE) 101 04 615.4

(51) Int. Cl. H05H 1/24

(52) U.S. Cl. 427/569

(57) ABSTRACT

A method is proposed for producing a functional coating on a substrate (19) disposed in a chamber (40), a plasma (21) being generated by an inductively coupled, high-frequency plasma jet source (5) having a burner member (25) which delimits a plasma generating space (27) and has a discharge aperture (26). This plasma (21) then exits via the discharge aperture in the form of a plasma jet (20) from the plasma jet source (5) and enters into the chamber (40) connected thereto, where it acts on the substrate (19) for producing the functional coating. In this context, it is also provided that between the interior of the chamber (40) and the plasma generating space (27), at least at times a pressure gradient is produced which accelerates particles contained in the plasma jet (20) toward the substrate (19).

The present invention relates to a method for producing a functional coating on a substrate with the aid of an inductively coupled, high-frequency plasma jet source of the type set forth in the main claim.

### BACKGROUND INFORMATION

The application of functional coatings on substrates is a widely disseminated method for giving desired properties to the surfaces of workpieces or components. A customary method for producing such functional coatings is plasma coating in medium-high vacuum or high vacuum, which requires costly evacuation techniques, and in addition, furnishes only relatively low coating rates. Therefore, this method is time-intensive and expensive.

Thermal plasmas, with which high coating rates in the range of mm/h are attainable, are particularly suitable for coating substrates in the sub-atmospheric and atmospheric pressure range. For that, reference is made, for example, to R. Henne, “Contribution to Plasma Physics”, 39 (1999), Pages 385-397. Particularly promising among the thermal plasma sources is the inductively coupled, high-frequency plasma jet source (HF-ICP jet source), as is known from E. Pfender and C. H. Chang “Plasma Spray Jets and Plasma Particulate Interaction: Modelling and Experiments”, symposium volume of minutes of the 6th Workshop of Plasma Technology, TU Illmenau, 1998. In addition, a method for producing functional coatings using such a plasma jet source has already been proposed in the German Patent Application 199 58 474.5.

The advantages of the HF-ICP jet source lie, on the one hand, in the area of the working pressures in the source, which customarily extend from 50 mbar up to 1 bar and more, and on the other hand, in the great variety of usable materials able to be deposited employing such a plasma jet source. Especially due to the fact that the starting materials are introduced axially into the very hot plasma jet, hard materials having very high melting temperatures are also usable. In addition, HF-ICP jet sources function without electrodes, that is to say, impurities in the coatings to be produced due to electrode material from the jet source are ruled out.

### SUMMARY OF THE INVENTION

Compared to the related art, the method of the present invention for producing a functional coating on a substrate has the advantage that, due to the pressure gradient between the plasma source and the chamber, an accelerated and expanded plasma jet is formed, in which the particles contained therein emerge from the plasma jet source at least partially with a velocity on the order of magnitude of sonic velocity or even supersonic velocity, and act on the substrate so that such a plasma jet is also able to reach deep cavities in the substrate and/or to treat complicated geometries of the substrate.

Moreover, due to the high velocity of the plasma jet, which may easily be influenced via the pressure difference between the plasma jet source and the chamber, the expansion of the constantly present diffusion interface between the surface of the substrate and the plasma jet is also made smaller, thereby facilitating the diffusion of reactive plasma components onto the surface of the substrate. This results in a shortened treatment duration and/or intensified treatment of the substrate.

Furthermore, due to the expansion of the plasma jet upon emergence, which usually manifests in the form of a funnel-shaped widening of the plasma jet downstream of the discharge opening, a sudden cooling of the plasma jet is also achieved, which, on one hand, lowers the temperature load of the treated substrate, and on the other hand, leads to plasma-chemical changes in the plasma jet, particularly with respect to the reactive properties of the plasma, resulting in an increase in the coating rate and an improvement in the quality of the functional coating produced. In addition, because of the reduced temperature load, the selection of usable substrates is broadened, so that now all technically relevant substrate materials such as high-grade steel, sintered metals and even ceramics or polymers may be used.

Moreover, due to the decoupling achieved between the chamber in which the plasma treatment of the substrate takes place, and the interior of the plasma jet source, i.e. the plasma-generation space, with respect to the pressures prevailing in each place, the possibility exists of also using the plasma jet in medium-high vacuum under 1 mbar in the chamber, without the plasma mode, i.e. the pressure in the plasma jet source essentially changing. Therefore, the application range of the inductively coupled, high-frequency plasma jet source is perceptibly broadened. Advantageous further developments of the present invention are yielded from the measures indicated in the dependent claims.

Thus, because, on one hand, the pressure prevailing in the chamber during the deposition is lowered from customarily 100 mbar up to 1 bar, to less than 50 mbar, particularly less than 10 mbar, the ions present in the plasma have at their disposal an average free path which is sufficient so that, by way of an electric voltage coupled at least for a time into the substrate electrode and, via it, into the substrate, an effective acceleration of ions in the plasma jet toward the substrate may be produced without the effect of this acceleration voltage being lost again due to impacts. In addition, this low pressure further reduces the temperature load of the substrate.

On the other hand, it is advantageous that, even in the chamber in which the substrate is located, the plasma installation of the present invention requires only a low vacuum of less than 50 mbar, in order to ensure the ionic energy sufficient for the desired coating processes and surface modifications. A low vacuum may be produced reliably and quickly in the chamber of the plasma installation using customary pump devices, and, compared to a medium-high vacuum or a high vacuum as is necessary for CVD methods, requires a perceptibly reduced time expenditure and expenditure for equipment. Incidentally, due to the relatively high pressure in the chamber of the plasma installation compared to, for example, CDV methods, workpieces may now also be treated which are made, for example, of strongly outgassing sintered materials. Thus, all in all, one has at his disposal a high-rate deposition method which is also usable in low vacuum, accompanied by low process times and/or pump times.

Because the high-frequency plasma jet source and the chamber having the substrate are merely interconnected via the discharge aperture of the plasma jet source, it is also easily possible to maintain the desired pressure gradient using a suitable pump device connected to the chamber.

Moreover, it is advantageous if the action of an electric voltage on the substrate electrode is correlated with a periodic change in the intensity of the plasma jet generated by the plasma jet source. In this way, the temperature load of the substrate is further reduced on one hand, and on the other hand, due to the fluctuation in the intensity of the plasma jet, which preferably is also periodically quenched, disequilibrium states occur on a large scale in the plasma, it being possible to utilize the plasma disequilibrium states to deposit new types of coatings on the substrate. Furthermore, a great multitude of possibilities exist with respect to the selection of the materials, supplied to the plasma jet source or to the generated plasma jet, for producing the functional coating on the substrate; it is possible, for example, to fall back on those suggested in the German Patent 199 58 474.5.

In further advantageous developments of the present invention, to cool the substrate, a cooling device and/or a movable holding device that is preferably movable or rotatable in all spatial directions is/are provided, so that the substrate may be easily oriented relative to the plasma jets, and may also be cooled as desired during the plasma deposition.

Moreover, it is advantageous if the electric voltage acting on the substrate electrode is an electric voltage that is variable over time, particularly a pulsed electric voltage. In addition, it may be provided with an adjustable positive or negative offset voltage and/or be pulsed with a largely freely selectable pulse-to-pause ratio. Moreover, another parameter which is easy to change and is adaptable to the requirements of the individual case is the form of the envelope curve of the temporally variable electric voltage, which, for example, may have a saw-tooth-shaped, triangular or sinusoidal profile. Incidentally, the electric voltage used may also be a direct voltage. Further easy-to-change parameters with respect to the specific signal form of the electric voltage used are its edge steepness, its amplitude and its frequency. Besides that, it should be stressed that the time change of the voltage coupled into the substrate electrode does not necessarily have to be periodic.

### BRIEF DESCRIPTION OF THE DRAWING

The invention is explained in greater detail in the following description with reference to the Drawing.

FIG. 1 shows schematically, in section, a first exemplary embodiment of a plasma installation according to the invention, having an ICP plasma jet source; and

FIG. 2 shows an example for a variation over time in the intensity of the plasma jet produced.

FIGS. 3a through 3h show photos of the plasma jet, emerging from the plasma jet source, as a function of time, which is pulsed according to FIG. 2.

FIG. 4 shows a photo of a plasma jet emerging with high velocity from the plasma jet source.

FIG. 5 clarifies the plasma jet source according to FIG. 1 in detail.

### EXEMPLARY EMBODIMENTS

The present invention starts from an inductively coupled, high-frequency plasma jet source as is known in similar form from E. Pfender and C. H. Chang “Plasma Spray Jets and Plasma Particulate Interaction: Modelling and Experiments”, symposium volume of minutes of the 6th Workshop of Plasma Technology, TU Illmenau, 1998. Moreover, a coating process is carried out with it which has already been proposed in similar form in the German Patent 199 58 474.5.

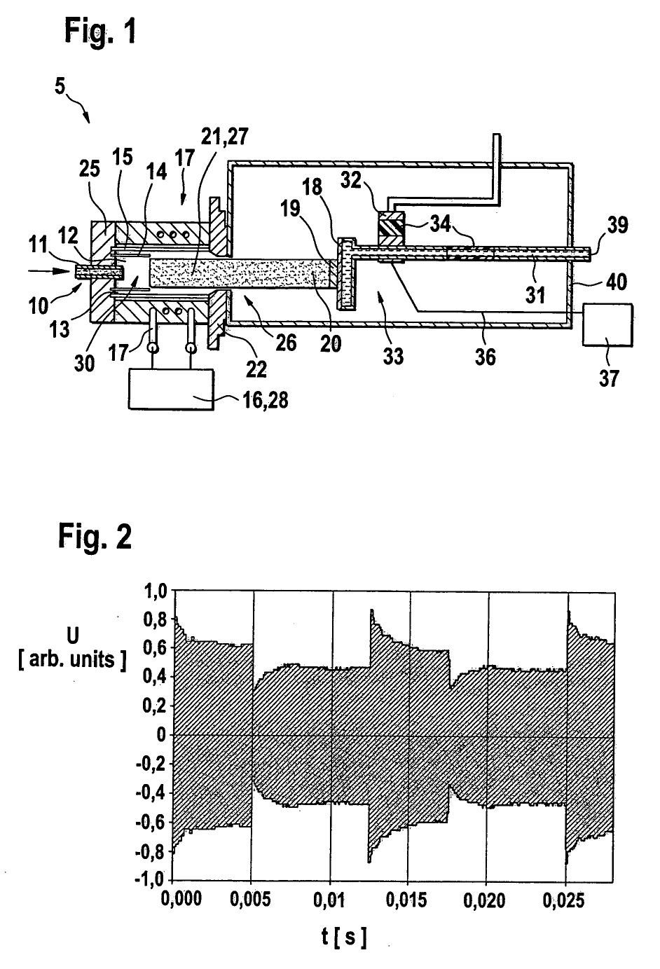

In detail, FIG. 1 shows an inductively coupled, high-frequency plasma jet source 5 having a pot-shaped burner member 25 which, on one side, has a discharge aperture 26 provided with a preferably variably adjustable or formed aperture stop 22, the discharge aperture, for example, being circular with a diameter of 1 cm to 10 cm. Plasma jet source 5 also has a coil 17 in the region of discharge aperture 26, integrated into burner member 25, for example, a water-cooled copper coil which, alternatively, may also be wound around burner member 25.

In addition, on the side of burner member 25 facing away from discharge aperture 26, a customary injector 10 for feeding an injector gas 11, a first cylindrical sleeve 14 and a second cylindrical sleeve 15 are provided. First sleeve 14 and second sleeve 15 are each formed concentrically with respect to the side wall of burner member 25, second sleeve 15 being used primarily to keep a plasma 21, generated in burner member 25 in a plasma generating space 27, away from the walls of burner member 25.

To that end, an envelope gas 13 is introduced via a suitable gas feed between first sleeve 14 and second sleeve 15 into burner member 25, the envelope gas also having the task of blowing generated plasma 21 in a jet shape out of plasma jet source 25 via discharge aperture 26, so that a plasma jet 20 is formed which, initially in a largely concentrated fashion, acts on a substrate 19, located in a chamber 40 on a substrate carrier 18 that, in the specific example, functions simultaneously as substrate electrode 18, in order to produce and/or deposit a functional coating there.

In the clarified example, envelope gas 13 is argon which is fed to plasma jet source 5 with a gas flow of 5000 sccm to 100,000 sccm, particularly 20,000 sccm to 70,0000 sccm.

It is also provided in FIG. 1 that coil 17 is electrically connected to a high-frequency generator 16, with which an electric power of 500 W to 50 kW, particularly 1 kW to 10 kW, at a high frequency of

0.5 MHz to 20 MHz is coupled into coil 17, and via it, also into plasma 21 which is ignited and maintained in plasma generating space 27.

In the preferred embodiment, high-frequency generator 16 is provided with an electrical component 28, known per se, with which the intensity of plasma jet 20 may be varied in its effect on substrate 19 periodically over time with a frequency of 1 Hz to 10 kHz, particularly

50 Hz to 1 kHz, between an adjustable upper and an adjustable lower intensity limit. In this context, plasma jet 20 is preferably also quenched periodically over an adjustable time duration, i.e., a selectable pulse-to-pause ratio.

FIG. 1 further shows that a central gas 12 may be fed via first sleeve 14 to the region between first sleeve 14 and injector 10. For example, this is an inert gas or a gas reacting with injector gas 11, particularly an inert gas to which a reactive gas is added.

In particular, provision is made that via injector 10 or a further feeding device situated between first sleeve 14 and injector 10, plasma 20 is fed a gaseous, microscale or nanoscale precursor material, a suspension of such a precursor material or a reactive gas which, in modified form, particularly after passing through a chemical reaction or a chemical activation, forms on substrate 19 the desired functional coating or is integrated into it there.

Alternatively, however, plasma 21 may also be used merely to chemically modify the surface of substrate 19, so that the desired functional coating thereby develops on the surface of substrate 19.

If a precursor material is fed to plasma 21 or plasma jet 20, preferably a carrier gas for this precursor material, particularly argon, and/or a reactive gas for a chemical reaction with the precursor material, particularly oxygen, nitrogen, ammonia, a silane, acetylene, methane or hydrogen is fed at the same time. Either injector 10, the feeding device for feeding central gas 12, or else the feeding device for feeding envelope gas 13 are suitable for feeding these gases. Alternatively or additionally, provision may also be made in chamber 40 for a further feeding device, e.g. an injector or a gas jet, for feeding a reactive gas and/or a precursor material into plasma jet 20 which has already emerged from plasma jet source 5.

The precursor material used is preferably an organic, a silicon-organic or a metalorganic compound which may therefore be fed to plasma 21 and/or plasma jet 20 in gaseous or liquid form, as microscale or nanoscale powder particles, as liquid suspension, particularly with microscale or nanoscale particles suspended therein, or as a mixture of gaseous or liquid substances with solid substances. By suitable selection of the individual gases, i.e. of the supplied reactive gases or of central gas 12 and of injector gas 11, as well as the selection of the precursor material, which is explained in detail in DE 199 58 474.5, a metal silicide, a metal carbide, a silicon carbide, a metal oxide, a silicon oxide, a metal nitride, a silicon nitride, a metal boride, a metal sulphide, amorphous carbon, diamondlike carbon (DLC), or also a mixture of these materials in the form of a layer or a succession of layers, for example, may be produced or deposited on substrate 19. The proposed method is also suitable for cleaning or carbonizing or nitriding the surface of substrate 19.

FIG. 1 also shows that substrate electrode 18 is able to be cooled with cooling water 39 via a cooling-water feed 31, and that substrate electrode 18, and therefore also substrate 19, is movable via a suitable holding device 32 in chamber 40. In this context, both holding device 32 and cooling-water feed 31 are electrically separated via an insulation 34 from substrate electrode 18 to which the electric voltage is being applied.

Preferably substrate 19, together with substrate electrode 18, is disposed on a holding device 32 that is movable, especially movable and/or rotatable in all spatial directions, so that the substrate may be both cooled and moved or rotated at least from time to time while producing the functional coating.

Moreover, substrate electrode 18 is electrically connected to a substrate generator 37, with which an electric voltage is coupled into substrate electrode 18, and via it, also into substrate 19. To that end, a generator supply lead 36 is provided between substrate generator 37 and substrate electrode 18.

In detail, substrate electrode 18 receives from substrate generator 37 an electric DC voltage or an AC voltage having an amplitude between 10 V and 5 kV, particularly between 50 V and 300 V, and a frequency between 0 Hz and 50 MHz, particularly between 1 kHz and 100 kHz. In addition, this DC voltage or AC voltage may also be supplied from time to time or continually with a positive or negative offset voltage.

The coupled-in electric voltage is preferably an electric voltage that is variable over time, particularly a pulsed electric voltage having a pulse-to-pause ratio to be selected in the individual case on the basis of simple preliminary experiments, as well as an offset voltage possibly varying over time as well, e.g., with respect to the operational sign.

Furthermore, the time variation of the electric voltage is preferably adjusted so that its envelope curve has a unipolar or bipolar saw-tooth-shaped, triangular, rectangular or sinusoidal profile. Further parameters in this context are the amplitude and polarity of the offset voltage, the edge steepness of the individual pulses of the coupled-in electric voltage, the frequency (carrier frequency) of this voltage as well as its amplitude.

One especially preferred embodiment of the method according to the present invention provides that the change in the intensity of plasma jet 20 by way of high-frequency generator 16 and electric component 28 integrated therein—which, incidentally, may also be implemented as a separate electrical component and then connected between coil 17 and high-frequency generator 16—particularly the pulsing of plasma jet 20, is carried out in a manner correlated in time to the change or the pulsing of the electric voltage coupled into substrate electrode 18.

Furthermore, this time correlation is preferably a pulsing of the intensity of plasma jet 20 that is in phase opposition or displaced in time with respect to the change or the pulsing of the electric voltage.

Finally, FIG. 1 indicates that located in the interior of plasma jet source 5 is a first pressure region 30 in which a pressure of 1 mbar to 2 bar, particularly

100 mbar to 1 bar prevails. In the interior of chamber 40 is then a second pressure region 33 having a pressure of less than 50 mbar, particularly between 1 mbar to

10 mbar. In this context, the pressure in first pressure region 30 is constantly perceptibly greater than the pressure in second pressure region 33, so that a pressure gradient directed into the interior of chamber 40 develops, although, as explained, gas is permanently fed to plasma jet source 5 during operation, and plasma jet source 5 and chamber 40 are interconnected in an open manner via discharge aperture 26.

The pressures are preferably selected so that the ratio of the pressure in first pressure region 30 to the pressure in second pressure region 33 is greater than 1.5, especially greater than 3.

To maintain this pressure difference between first and second pressure regions 30, 33, and particularly to keep the pressure in chamber 40 below 50 mbar, adequately dimensioned pump devices, known per se, are connected to chamber 40. They assure that, for example, a pressure difference of, for instance, more than 100 mbar develops between plasma generating space 27 in the interior of plasma jet source 5 and the interior of chamber 40.

Due to the explained pressure difference, plasma jet 20 emerges with high velocity from plasma jet source 5 or is blown out of it, so that the reactive components contained in plasma 21 strike with correspondingly high velocity on substrate 19. At the same time, deviating from the schematic representation in FIG. 1, usually a funnel-shaped widening or expansion of the plasma jet occurs after passing through discharge orifice 26.

Suitable as material for substrate 19 when carrying out the method of the present invention are both electrically conductive and, given suitable selection of the temporally variable voltage at the substrate electrode, electrically insulating materials. In addition, as a result of the decrease in the temperature load of substrate 19 provided by the cooling device and particularly by the pulsing of plasma jet 20, temperature-sensitive substrates such as polymers may also be used.

FIG. 2 clarifies how plasma jet 20, due to a change over time of the voltage supplied by high-frequency generator 16 in cooperation with electrical component 28 to coil 17, is changed in its intensity corresponding to the change of this voltage. In particular, in continuation of FIG. 2, the voltage at coil 17 may also temporarily be 0, so that plasma jet 20 is extinguished during this time.

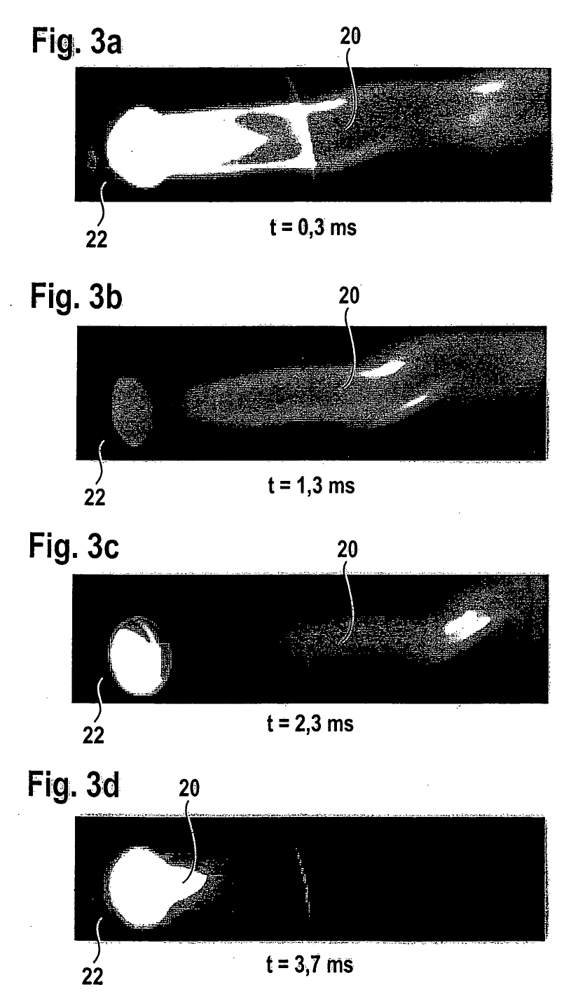

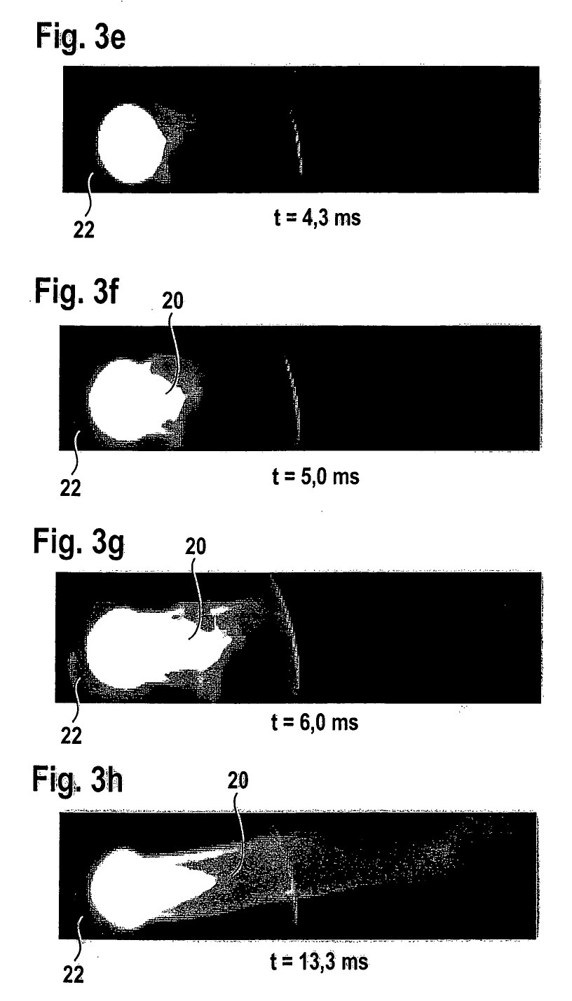

FIGS. 3a through 3h directly show plasma jet 20 in chamber 40, emerging from discharge aperture 26 via aperture stop 22. The typical distance between discharge aperture 26 and substrate 19 is 5 cm to 50 cm.

One sees in FIGS. 3a through 3h how plasma jet 20 according to FIG. 3a initially emerges with high intensity from discharge aperture 26 at time t=0; according to FIG. 3b, this intensity then changes markedly, so that shortly after that, plasma jet 20 is completely extinguished; according to FIGS. 3c through 3e, the plasma jet is subsequently reignited and, at the same time, pulsates back briefly before it then expands continually according to FIGS. 3f through 3h, so that after 13.3 ms, the starting state according to FIG. 3a is nearly reached again. This pulsing of plasma jet 20 according to FIGS. 3a through 3h is caused by a change in the high-frequency electric power coupled into coil 17.

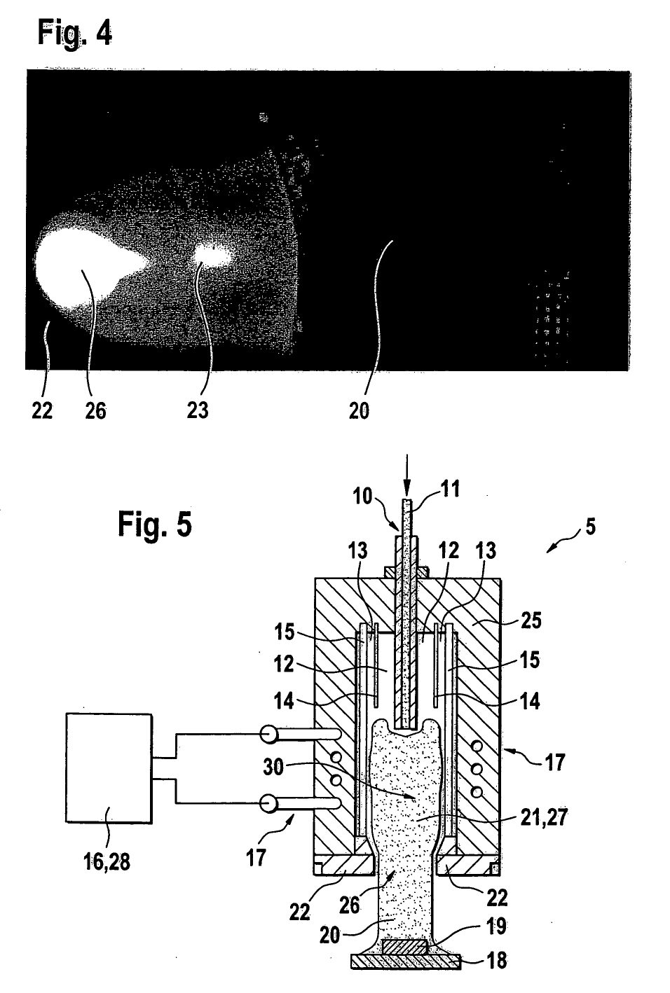

FIG. 4 clarifies how, due to a suitably high pressure difference between the interior of plasma jet source 5 and the interior of chamber 40, i.e. the explained pressure gradient toward chamber 40, plasma jet 20 exits at a given point of time with high velocity from discharge aperture 26, and acts on substrate 19 with a correspondingly high velocity. In particular, a compression node 23 (Mach node) is discernible in FIG. 4, which verifies that the velocity of the particles in plasma jet 20 is on the same order of magnitude as sonic velocity. However, for example, higher velocities, especially supersonic velocities, produced by correspondingly greater pressure differences are also achievable. In addition, FIG. 4 shows that downstream of discharge aperture 26, plasma jet 2b expands in chamber 40.

Incidentally, the pressure gradient produced is preferably so strong that at the location of substrate 19, particles contained in plasma jet 20 have essentially been accelerated to a velocity which is greater than half the sonic velocity in plasma jet 20.

FIG. 5 clarifies a section from FIG. 1, plasma jet source 5 again being shown enlarged. In this case, the arrangement of injector 10 and the embodiment of first sleeve 14 and second sleeve 15, in particular, are more clearly discernible.

What is claimed is:

1. A method for producing a functional coating on a substrate (19) disposed in a chamber (40), an inductively coupled, high-frequency plasma jet source (5) being used to generate a plasma (21) having reactive particles, the plasma in the form of a plasma jet (20) from the plasma jet source (5) entering into the chamber (40) connected thereto and acting on the substrate (19) in such a way that a functional coating is produced or deposited on the substrate (19), wherein between the interior of the chamber (40) and plasma generating space (27), at least at times a pressure gradient is produced which accelerates particles contained in the plasma jet (20) onto the substrate (19).

2. The method as recited in claim 1, wherein using a pump device connected to the chamber (40), a pressure difference of more than 100 mbar, particularly more than 300 mbar, is produced between the plasma generating space (27) in the interior of the plasma jet source (5) and the interior of the chamber (40) and/or the ratio of the pressure in the plasma generating space (27) to the pressure in the interior of the chamber (40) is greater than 1.5, particularly greater than 3.

3. The method as recited in claim 1 or 2, wherein the plasma jet source (5) is operated at a pressure of 1 mbar to 2 bar, especially 100 mbar to 1 bar, and the pressure in the chamber (40) is held below 50 mbar, particularly between 1 mbar to 10 mbar.

4. The method as recited in one of claims 1 through 3, wherein by feeding a gas, especially argon, with a gas flow of 5000 sccm to 100,000 sccm, particularly 20,000 sccm to 70,000 sccm, to the plasma jet source (5), the plasma (21) is blown in the shape of a jet out of the plasma jet source (5) and conveyed into the chamber (40).

5. The method as recited in one of the preceding claims, wherein due to the feed of the gas to the plasma jet source (5) and/or the pressure gradient between the plasma jet source (5) and the chamber (40), at the location of the substrate (19), particles contained in the plasma jet (20) are accelerated to a velocity which is greater than half the sonic velocity in the plasma jet (20), in particular is comparable to or greater than the sonic velocity in the plasma jet (20).

6. The method as recited in one of the preceding claims, wherein the functional coating is produced by depositing at least one layer using the plasma jet (20) and/or by modification of a surface layer of the substrate (19) using the plasma jet (20).

7. The method as recited in one of the preceding claims, wherein the substrate (19) is arranged in the chamber (40) on a substrate electrode (18), and is acted upon by an electric voltage at least at times while the functional coating is being produced.

8. The method as recited in claim 7, wherein the substrate electrode (18) is acted upon via a substrate generator (37) by an electric DC voltage or an electric AC voltage having an amplitude between 10 V and 5 kV, particularly between 50 V and 300 V, and a frequency between 0 Hz and 50 MHz, particularly between
1 kHz and 100 kHz.

9. The method as recited in claim 7 or 8, wherein the electric voltage is changed over time, in particular is provided at least at times with an adjustable offset voltage and/or is pulsed with a selectable pulse-to-pause ratio.

10. The method as recited in one of the preceding claims, wherein an electric power of 500 watts to 20 kW, particularly 0.5 kW to 50 kW, at a high frequency of
0.5 MHz to 20 MHz is coupled into the plasma (21) of the inductively coupled high-frequency plasma jet source (5) via a coil (17).

11. The method as recited in one of the preceding claims, wherein the intensity of the plasma jet (20) in the influence on the substrate (19) is altered periodically over time with a frequency of 1 Hz to 10 kHz, particularly 50 Hz to 1 kHz, between an adjustable upper and an adjustable lower limit, and in particular, the plasma jet (20) is also extinguished periodically over an adjustable time duration.

12. The method as recited in one of the preceding claims, wherein fed to the plasma (21) via an injector (10) in the plasma jet source (5) and/or fed to the plasma jet (20) via a feeding device in the chamber (40) is at least one, in particular, gaseous or microscale or nanoscale precursor material, a suspension of such a precursor material or a reactive gas which, in modified form, particularly after passing through a chemical reaction or a chemical activation, forms the functional coating on the substrate (19) or is integrated into the functional coating.

13. The method as recited in one of the preceding claims, wherein a carrier gas for the precursor material, particularly argon, and/or a reactive gas for a chemical reaction with the precursor material, particularly oxygen, nitrogen, ammonia, silane, acetylene, methane or hydrogen is fed to the plasma (21) in the plasma jet source (5).

14. The method as recited in one of the preceding claims, wherein the precursor material is an organic, a silicon-organic or a metalorganic compound which is fed to the plasma (21) and/or to the plasma jet (20) in gaseous or liquid form, as microscale or nanoscale powder particles, as liquid suspension, particularly with microscale or nanoscale particles suspended therein, or as a mixture of gaseous or liquid substances with solid substances.

15. The method as recited in one of the preceding claims, wherein the change in the intensity of the plasma jet (20), especially the pulsing of the plasma jet (20), is carried out in a temporally correlated manner, particularly in phase opposition or displaced in time, with respect to the change or the pulsing of the electric voltage which acts on the substrate electrode (18).
